(19) United States
(12) Patent Application Publication
(10) Pub. No.: US 2006/0191724 A1
(43) Pub. Date: Aug. 31, 2006

(54) Appliance transporting system

(76) Inventor: David Mairose, Le Mars, IA (US)

Correspondence Address: WOODS FULLER SHULTZ & SMITH P.C.;ATTN: JEFFREY A. PROEHL, P.O. BOX 5027, SIOUX FALLS, SD, 57117, US

(21) Appl. No.: 11/337,320

(22) Filed: Jan. 23, 2006

Related U.S. Application Data
(63) Continuation-in-part of application No. 10/236,171, filed on Sep. 6, 2002.

(51) Int. Cl. B62D 51/06

(52) U.S. Cl. 180/8.2

(57) ABSTRACT

An appliance transporting apparatus for facilitating the movement of large objects, such as household appliances, up and down stairs. The appliance transporting apparatus includes an elongate frame having an upper end and a lower end with a longitudinal axis extending between the ends. The frame also has a lower portion of the frame generally defining a plane. The apparatus includes a ground engaging structure mounted on the frame for facilitating movement of the frame across a ground surface, with the ground engaging structure being located at laterally spaced locations on the frame. A climbing structure is mounted on the frame for facilitating movement of the frame up and down a ledge. The climbing structure defines a support surface oriented at an acute angle with respect to the plane generally defined by the lower portion of the frame. The climbing structure extends substantially the entire distance between the laterally spaced locations of the ground engaging structure.

### CROSS REFERENCE TO RELATED APPLICATION

This application is a continuation-in-part of application Ser. No. 10/236,171, filed Sep. 6, 2002.

### BACKGROUND OF THE INVENTION

1. Field of the Invention

The present invention relates to appliance dollies and more particularly pertains to a new appliance transporting system for facilitating the movement of large objects, such as household appliances, up and down stairs.

2. Description of the Prior Art

The use of appliance dollies and hand carts or trucks is known for transporting objects that are too heavy or two bulky for hand lifting and carrying without assistance. These known devices are best suited for transport over relatively flat and generally horizontal surfaces, as they are generally equipped with smaller wheels that are highly maneuverable but don't roll well over uneven surfaces or surfaces with holes. Ascending and descending ledge structures—such as curbs and stairs—is especially problematic for these devices, as a portion of the frame of the device often is slid across the ledge structure until the wheels can engage the relatively higher or lower surface of the ledge.

Various devices have been proposed and utilized for facilitating the movement of the device and the object being transported across the ledge structures. Such known structures includes laterally-spaced skid bars and laterally-spaced movable straps that are each located adjacent to one of the wheels of the device, with a gap in between the skid bars or movable straps. These relatively narrow structures tend to concentrate the weight of the device (and the object being carried on the device) in a pair of relatively narrow areas, and this characteristic can increase the possibility of damaging the edges of the stair treads, especially those made of a soft material such as wood. Further, the lateral spacing of the skid bars and movable straps require careful alignment of these narrow elements with steps or other ledge structures so that one of the narrow elements does not miss or slip off of the ledge while the device is traversing the ledge.

In these respects, the appliance transporting system according to the present invention substantially departs from the conventional concepts and designs of the prior art, and in so doing provides an apparatus primarily developed for the purpose of facilitating the movement of large objects, such as household appliances, up and down stairs.

### SUMMARY OF THE INVENTION

In view of the foregoing disadvantages inherent in the known types of appliance dollies now present in the prior art, the present invention provides a new appliance transporting system construction wherein the same can be utilized for facilitating the movement of large objects, such as household appliances, up and down stairs.

To attain this, the present invention generally comprises an elongate frame having an upper end and a lower end with a longitudinal axis extending between the ends. The frame also has a lower portion of the frame generally defining a plane. The apparatus includes a ground engaging structure mounted on the frame for facilitating movement of the frame across a ground surface, with the ground engaging structure being located at laterally spaced locations on the frame. A climbing structure mounted on the frame for facilitating movement of the frame up and down a ledge. The climbing structure defines a support surface oriented at an acute angle with respect to the plane generally defined by the lower portion of the frame. The climbing structure extends substantially the entire distance between the laterally spaced locations of the ground engaging structure.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

One significant advantage of the present invention is the ability to move objects over one or more ledge structures with a minimum risk of damage to the ledge structure, while not requiring careful alignment of the climbing means with the ledge structure so that the ledge is securely addressed.

The advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic side view of a new appliance transporting system according to the present invention.

FIG. 2 is a schematic rear view of a portion of the present invention looking downward on the climbing means.

FIG. 3 is a schematic side view of a lower portion of the present invention with some of the side covering removed to show detail of the invention.

FIG. 4 is a schematic rear view of a lower portion of the present invention.

FIG. 5 is a schematic diagram of the relationship of the various electrical elements of the present invention.

FIG. 6 is a schematic front view of a second embodiment of the present invention.

FIG. 7 is a achematic side sectional view of the second embodiment shown in FIG. 6 taken along line 7-7 in FIG. 6.

FIG. 8 is a schematic front sectional view of the second embodiment shown in FIG. 6 taken along line 8-8 of FIG. 7.

FIG. 9 is a schematic end sectional view of the second embodiment shown in FIG. 6 taken along line 9-9 of FIG. 8.

### DESCRIPTION OF PREFERRED EMBODIMENTS

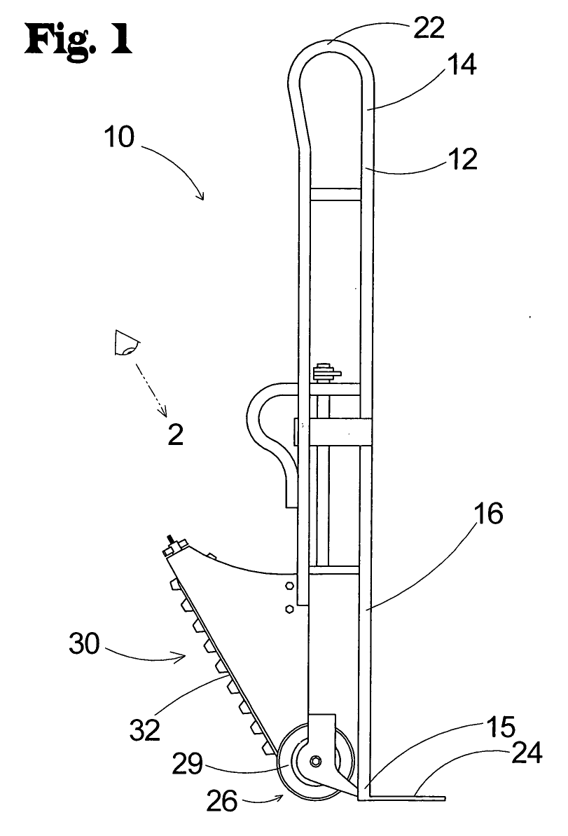

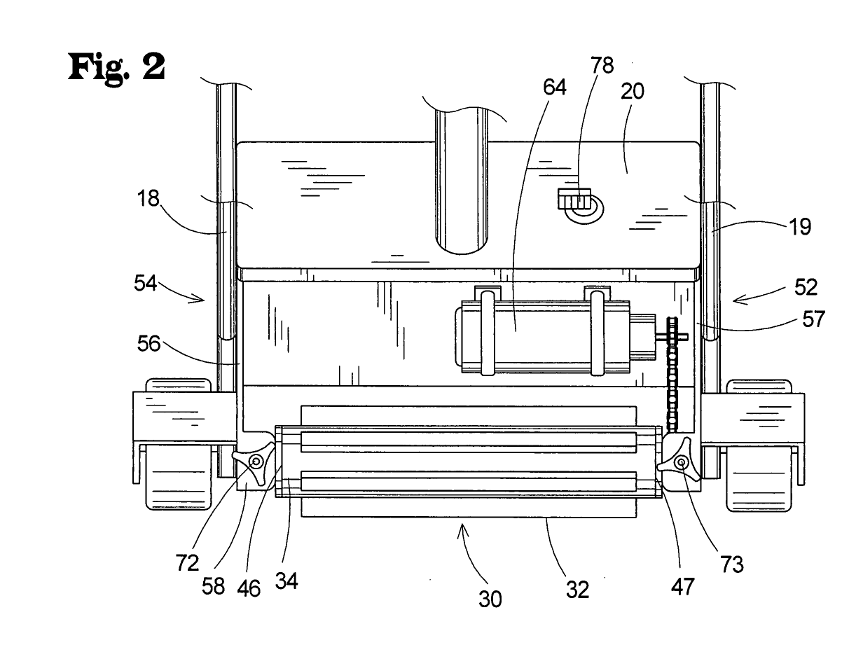

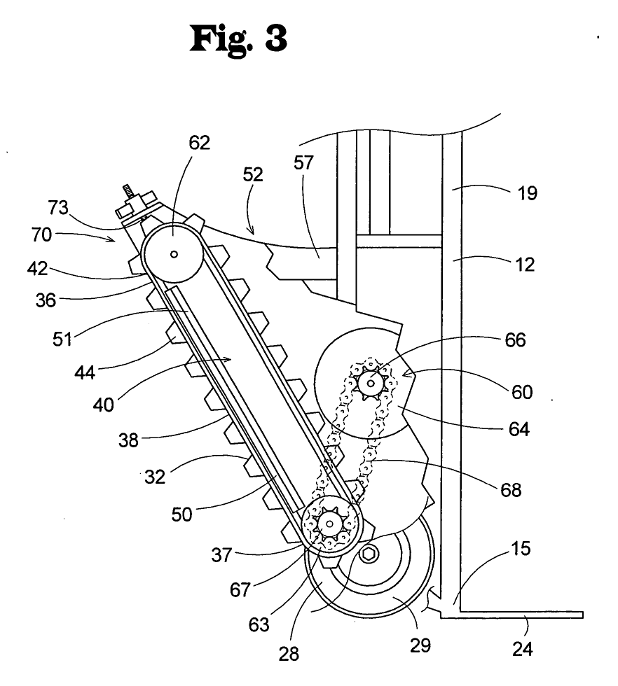

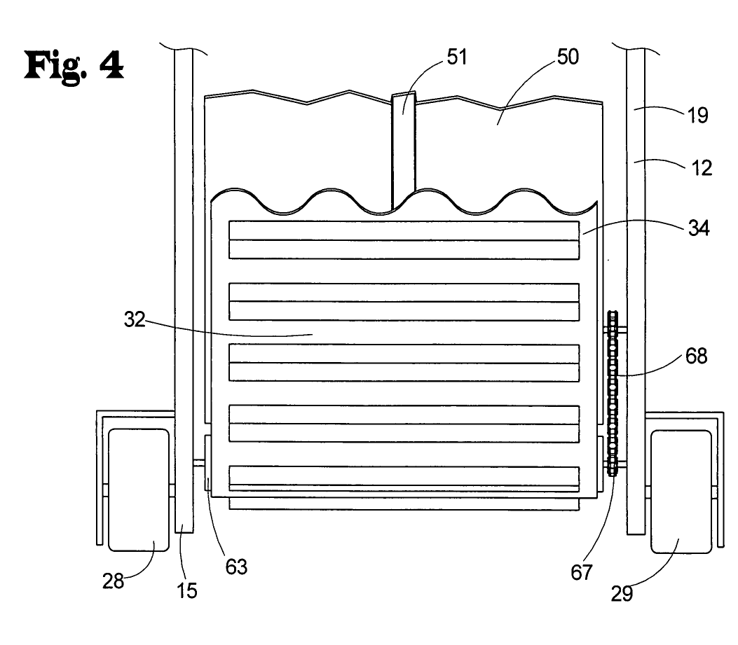

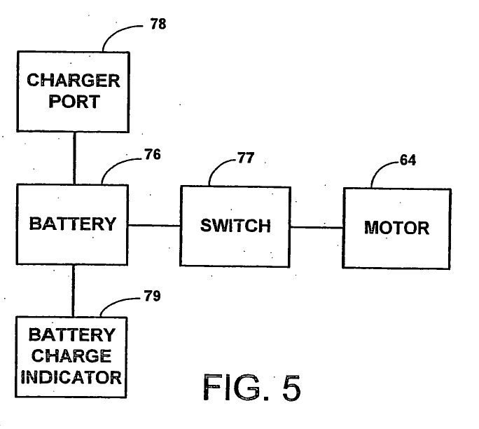

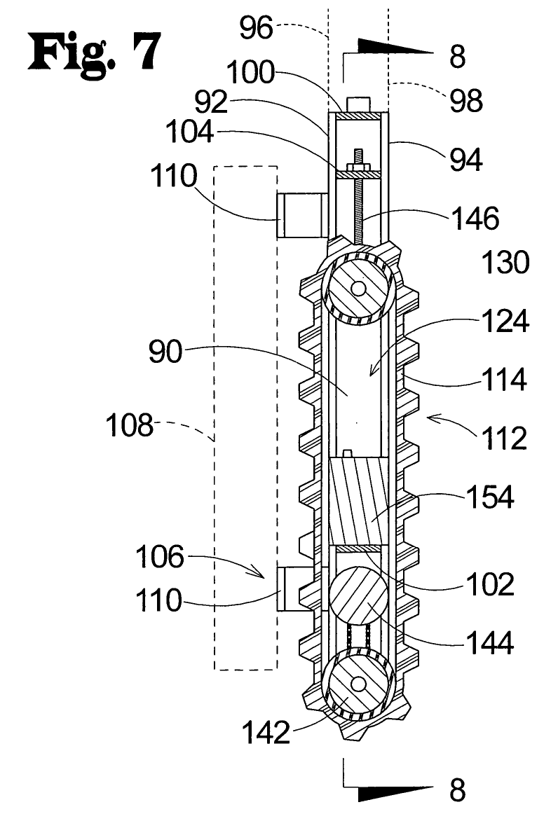

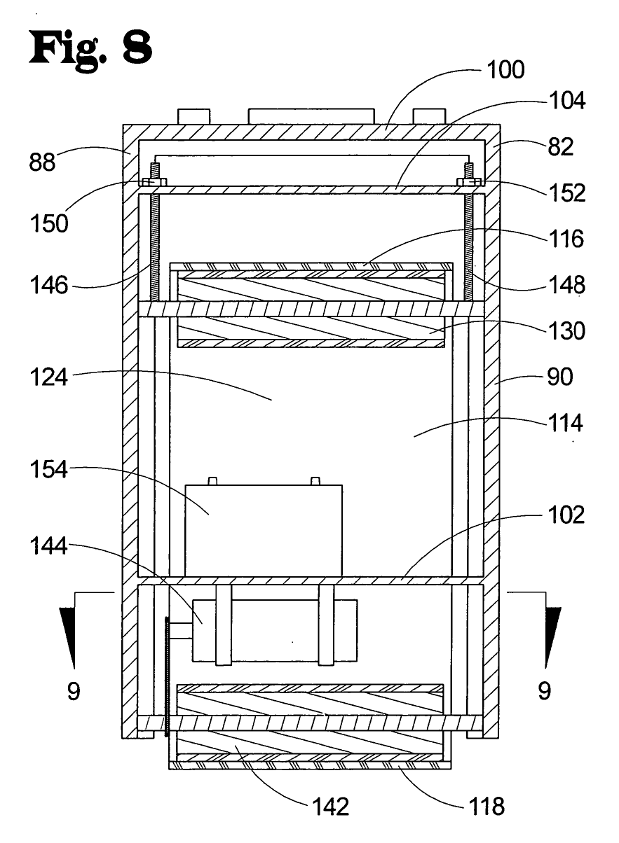

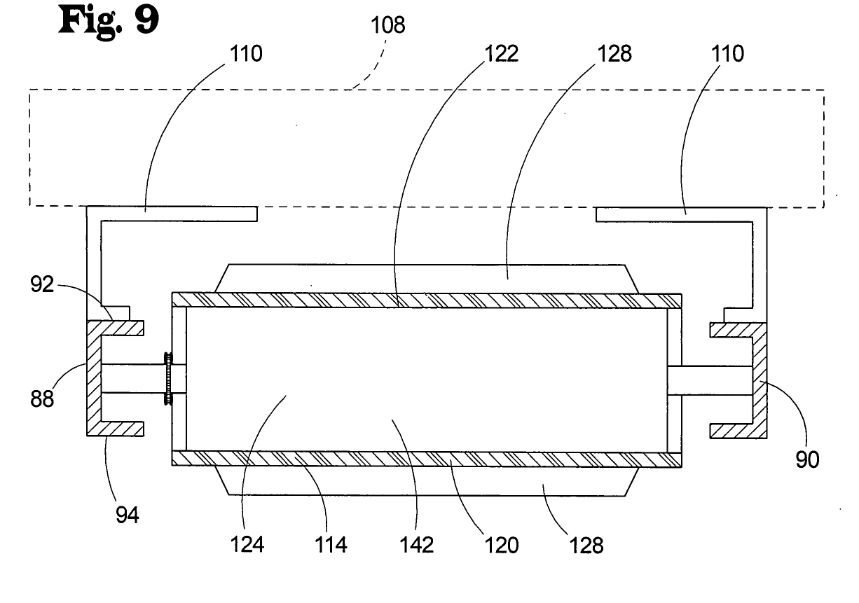

With reference now to the drawings, and in particular to FIGS. 1 through 9 thereof, a new appliance transporting system embodying the principles and concepts of the present invention will be described.

As best illustrated in FIGS. 1 through 9, the appliance transporting system is highly suitable for moving objects over ledge structures in upward and downward directions with respect to the ledge structures. The ledge structure as referred to in this application may include stairs, curbs, relatively low loading docks, or generally any interruption in a relatively flat surface. The objects transportable with the invention may include relatively large and heavy objects (such as, for example, household appliances), as well as relatively smaller and lighter objects.

The apparatus of the invention may take forms that may generally resemble devices typically referred to as appliance dollies and hand trucks or hand carts, although other transporting devices could suitably employ the invention for moving the devices up and down ledge structures. It should be understood that the width and overall size of the apparatus may be varied to carry relatively larger or smaller objects on the apparatus.

in the embodiment shown generally in FIGS. 1 through 5, the appliance transporting apparatus 10 of the invention generally comprises an elongate frame 12, a ground engaging means mounted on the frame for facilitating movement of the frame across a ground surface, and a climbing means mounted on the frame for facilitating movement of the frame up and down a ledge.

In greater detail, the frame of the appliance transporting apparatus has an upper end 14 and a lower end 15, with a longitudinal axis extending between the ends. A lower portion 16 of the frame 12 generally defines a plane. The frame 12 may include a pair of side rails 18, 19 that extend longitudinally and at least one lateral member 20 extending laterally between the side rails. A handle structure 22 may be mounted on the frame 12 for being gripped by a user, and in one embodiment the handle structure 22 is formed on the upper end 14 of the frame 12, although other positions may be employed.

A lift plate 24 may be provided for positioning below an object to be transported. The lift plate 24 may be mounted on the frame 12 at the lower end 15 of the frame, and may extend substantially perpendicular to the plane defined by the lower portion 16 of the frame.

The ground engaging means or structure 26 may be located at the lower end 15 of the frame 12. The ground engaging structure 16 may comprise at least one wheel 28, and preferably includes a pair of laterally spaced wheels 28, 29 mounted on the frame. The wheels may be mounted on an axle, and may be of a solid, a substantially solid, or a hollow air filled type.

The climbing means or structure 30 may be mounted on the frame 12 toward the lower end 15 of the frame. The climbing structure 30 may define a support surface 32 that is oriented at an acute angle with respect to the plane generally defined by the lower portion of the frame. The climbing structure 30 may include an endless belt 34 that has an upper end portion 36 positioned toward the upper end 14 of the frame 12 and a lower end portion 37 positioned toward the lower end 15 of the frame. The lower end portion 37 of the endless belt 34 may extend between the wheels 28, 29 of the ground engaging structure, while the upper end portion 36 extends to a vertical level above the wheels, and the support surface on the endless belt may extend in a substantially tangential relationship to an outer perimeter of the wheels for facilitating smooth transitional movement of a ledge between the wheels and the endless belt and the endless belt and the wheels.

The endless belt 34 has a rearward stretch 38 that may define all or part of the support surface 32. The endless belt 34 has an interior space 40, and an outward perimeter surface 42 that may be provided with a plurality of ribs 44 formed thereon. The plurality of ribs 44 may extend laterally between side edges 46, 47 of the endless belt 34. The plurality of ribs 44 may be substantially uniformly spaced along a longitudinal direction of the endless belt. It should be noted that although the belt is referred to herein as being endless, the endless belt may be formed from a belt having ends that are securely connected together to form a belt without ends.

Significantly, the endless belt 34 may extend laterally substantially an entire distance between the wheels of the ground engaging structure for maximizing secure and stable engagement between the belt and the surface of a ledge structure. The endless belt 34 of the invention thus presents a substantially continuous support surface 32 between the wheels without significant gaps, especially at a central location between the wheels. This feature of the invention serves to distribute the weight of the apparatus and the object being carried over a larger area of a ledge structure, thus minimizing the possibility of damage to the ledge due to excessive pressure being applied to a few locations on the ledge. Further, the user is provided with a much wider area of the belt 34 to address the ledge without having to be concerned with alignment of narrow elements with the ledge so as not to possibly upset the apparatus and the object as the combination moves across the ledge.

The climbing structure 30 may also include a support plate 50 for supporting the rearward stretch 38 of the endless belt 34 between the upper 36 and lower 37 end portions of the belt. The support plate 50 may position the rearward stretch 38 of the endless belt 34 at the acute angle. The support plate 50 is positioned in the interior space 40 of the endless belt 34 such that the rearward stretch 38 moves along or across a face of the support plate. The support plate 50 preferably extends substantially the entire distance between the wheels 28, 29 for supporting the entire width of the belt between the wheels. The support plate 50 may be oriented at the acute angle with respect to the plane defined by the lower portion of the frame. The acute angle preferably has a measurement in the range of approximately 10 degrees and approximately 30 degrees. The support plate 50 may also have a groove 51 formed in the face of the support plate for receiving a rib formed on an interior side of the endless belt to resist movement of the belt from a substantially central position on the support plate as the belt moves across the support plate.

The climbing structure 30 may also include a support structure 52 for supporting the endless belt 34 on the frame 12. The support structure 52 may comprise a spacing assembly 54 for spacing the upper end portion 36 of the endless belt 34 from the frame 12 a relatively greater distance than the lower end portion 37 of the endless belt 34. In one embodiment of the invention, the spacing assembly 54 includes a pair of laterally spaced spacer members 56, 57, and he spacer members extend outwardly from the frame 12. The spacer members 56, 57 may be oriented substantially perpendicular to the plane defined by the lower portion of the frame. The spacing assembly may also include a pair of side members 58, 59 that extend between the spacer members 56, 57 and the frame 12. Each of the side members 58, 59 may extend from an end of one of the spacer members 56, 57 to the lower end 15 of the frame.

The climbing structure 30 may also include a rotating means or structure 60 for rotating the endless belt 34. The rotating structure 60 may comprise a pair of rollers 62, 63 on which the endless belt is mounted. Each of the rollers 62, 63 may be positioned at each of the end portions 36, 37 of the endless belt 34. The rollers 62, 63 may be mounted on the side members 58, 59 of the support structure 52, with an upper one 62 of the rollers being located generally above a lower one 63 of the rollers. Ideally, the support plate 50 has an outer surface oriented in a plane that is generally tangential to the outer surfaces of the rollers. Each of the rollers may also have a circumferential groove formed therein for receiving the rib formed on the interior side of the endless belt for further guiding the belt as it is rotated.

The climbing structure 30 may include a motor 64 for rotating the rollers 62, 63, and which may be mounted on the frame 12. The motor 64 preferably is rotatable in a first and second direction. The rotating structure 60 may further include a pair of sprockets 66, 67 and a drive chain 68 that connects the sprockets. A first one 66 of the sprockets may be mounted on the motor 64 and a second one 67 of the sprockets may be mounted on one of the rollers 62, 63 for transmitting rotational motion between the motor and the roller.

Optionally, the climbing structure 30 may include a tensioning means or structure 70 for adjusting tension of the endless belt 34. The tensioning structure 30 permits adjustment of a distance between the rollers 62, 63. The tensioning structure may comprise a pair of threaded members 72, 73 that each have a first end mounted on an axle of one of the rollers and each having a second end mounted on a portion of the spacing assembly for varying a distance between the axle of the roller and the point on the spacing assembly where the second end is mounted.

The invention may also include a power supply assembly 74 for providing power to the rotating structure 60. The power supply assembly may comprise a battery 76 mounted on the frame 12, suitably at a lower location on the frame to facilitate a low center of gravity for the invention. The power supply assembly 74 may also include a switch 84 for selectively providing power from the battery 76 to the motor 64. The switch 77 may have a first position for causing the motor 64 and the endless belt 34 to rotate in a first direction and a second position for rotating the motor and the endless belt in a second direction. With the use of the switch and a bidirectional motor, the endless belt 34 may be rotated in one direction for moving the invention (and any object supported thereon) upward onto a ledge, and may be rotated in the opposite for lowering the invention down off of a ledge. The switch 77 may preferably comprise a momentary switch that permits power flow only when the switch is being pressed or otherwise being actuated by the user so that the moor and endless belt do not continue to operate when the switch is not actively being actuated. The power supply assembly 74 may also include a charger port 78 for receiving power to recharge the battery. The charger port 78 may optionally be adapted to receive both AC and DC current for recharging the battery, and may convert the AC power to DC for the charging process. As a further option, the power supply assembly may further include a battery charge indicator 79 for indicating an amount of electrical charge in the battery 76. The battery charge indicator 79 may comprise a light that illuminates when the charge in the battery 76 drops below a predetermined charge level.

In one illustrative embodiment of the invention, the belt may have a width of approximately 12 inches and an overall longitudinal extent of approximately 50 inches. For embodiments of the invention designed to support relatively larger objects, the belt may have a greater width, such as, for example, approximately 18 inches wide.

In use, the apparatus 10 is moved adjacent to the object to be moved, and the lift plate 24 is positioned below the object. The frame 12 is tilted to lift the object on the lift plate, and the apparatus may be moved over relatively flat surfaces using the wheels of the ground engaging structure. When a ledge structure such as a curb or ledge is encountered, the endless belt of the climbing structure is positioned such that the support surface on the belt engages the curb or lowermost step, and the rotating structure is actuated through the switch to begin rotation of the endless belt in a direction such that the rearward stretch of the endless belt descends or moves downwardly with respect to the support plate. The belt, and the plurality of ribs formed thereon, engage the ledge and move the frame with respect to the ledge. In the case when the apparatus and the object are to be moved downward with respect to a ledge structure, the wheels of the ground engaging structure may be rolled over the ledge so that the apparatus rests on the endless belt, and the rotating structure may be actuated through the switch to rotate the belt such that the belt moves in an upward direction with respect to the support plate so that the belt engages the ledge and facilitates a controlled descent rate for the frame with respect to the ledge.

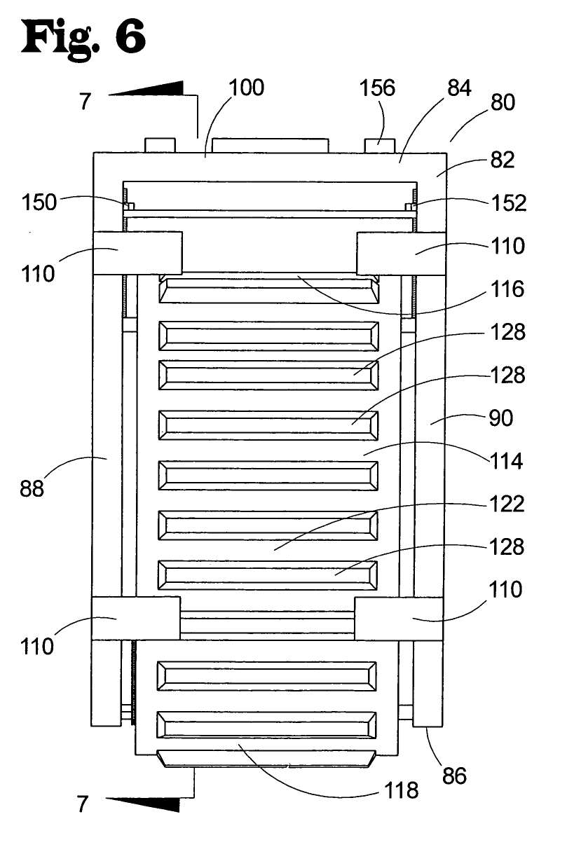

Turning now to FIGS. 6 through 9, and the second embodiment shown therein, the apparatus 80 will now be described in greater detail. The second embodiment of the appliance transporting apparatus, generally designated by the reference number 80, includes an elongate frame 82 having an upper end 84 and a lower end 86. The frame has a longitudinal axis (not shown) that extends between the upper 84 and lower 86 ends. The frame 82 includes a pair of laterally spaced frame members 88, 90 extending between the upper end 84 and the lower end 86 of the frame. Each of the frame members 88, 90 has a front surface 92 and a rear surface 94. The front surfaces 92 of the frame members 88, 90 define a front plane 96 of the frame, and the rear surfaces 94 of the frame members 88, 90 define a rear plane 98 of the frame. The frame 82 may also include a first cross member 100 that extends between the pair of frame members 88, 90. The first cross member 100 may be positioned toward the upper end 84 of the frame, and may act as a mounting for various controls of the apparatus. A second cross member 102 may extend between the pair of frame members 88, 90 and may be positioned between the first cross member 100 and the lower end 86 of the frame 82. A third cross member 104 may extend between the pair of frame members 88, 90, and may be positioned between the first cross member 100 and the second cross member 102.

The apparatus 80 may also include a load support structure 106 for supporting a load 108 on the frame 82, and preferably spacing the load away from the frame and the climbing structure (described below). The load support structure 106 may be mounted on the frame 82, and may be mounted on each of the frame members 88, 90. The load supporting structure 106 may comprise at least one bracket 110, which may be mounted on one of the frame members 88, 90. The load support structure 106 may comprise four of the brackets 108, with each of the brackets being mounted on the front surfaces 92 of the frame members 88, 90. Each of the brackets 110 may comprise a channel structure.

The apparatus 80 may also include a climbing structure 112 mounted on the frame 82 for facilitating movement of the frame 82 (and any load mounted thereon) up and down over a ledge. The climbing structure 112 may be mounted on the frame 82 toward the lower end 86 of the frame. Significantly, the climbing structure extends through the front plane 96 of the frame 82 and through the rear plane 98 of the frame. The climbing structure may include an endless belt 114 that has an upper end portion 116 positioned toward the upper end 84 of the frame and a lower end portion 118 positioned toward the lower end 86 of the frame. The endless belt 114 may have a rearward stretch 102 defining a support surface and a forward stretch 122 opposite the rearward stretch 102. The endless belt 114 may have an interior space 124. The endless belt 114 may have an outward perimeter surface 126 with a plurality of ribs 128 formed thereon. The plurality of ribs 128 extend laterally between side edges of the endless belt 114. The plurality of ribs 128 may be substantially uniformly spaced along a longitudinal direction of the endless belt.

The apparatus 80 may also include rotating apparatus for rotating the endless belt 114. The rotating apparatus may comprise a pair of rollers 130, 132 on which the endless belt 114 is mounted. Each of the rollers 130, 132 may be positioned at each of the end portions 116, 118 of the endless belt 114. The rollers 130, 142 may be mounted on the frame members 88, 90 of the frame and may extend between the frame members. The rotating apparatus may also comprise a motor 144 for rotating the rollers, and the motor 144 may be mounted on the frame 82. The motor 144 is also rotatable in a first and second direction, and is positioned in the interior space 124 of the endless belt 114.

The apparatus 80 may also include tensioning structure for adjusting the tension of the endless belt 114. The tensioning structure may accomplish this by adjusting a distance between the rollers 130, 142. In the illustrative embodiment of the invention shown in FIGS. 6 through 9, the tensioning structure includes a pair of rods 146, 148 attached to the blocks on which the upper roller 130 is mounted, and the rods extending through the third cross member 104 of the frame, and tensioning nuts 150, 152 are mounted on the respective rods to bear against the cross member 104 to pull the roller 130 toward the cross member 104 to increase the tension.

The apparatus 80 may also include power supply means for providing power to the motor 144. The power supply means may comprise a battery 154 positioned in the interior space 124 of the endless belt 114. The battery may be mounted on the second cross member 102 of the frame 82. A switch 156 for providing power from the battery 154 to the motor 144, and the switch may be mounted with other controls on the first cross member 100 of the frame 82.

It should be appreciated from the foregoing description that, except when mutually exclusive, the features of the various embodiments described herein may be combined with features of other embodiments as desired while remaining within the intended scope of the disclosure.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An appliance transporting apparatus comprising:
an elongate frame having an upper end and a lower end, the frame having a longitudinal axis, the frame comprising:
a pair of laterally spaced frame members extending between the upper end and the lower end, the each of the frame members having a front surface and a rear surface, the front surfaces of the frame members defining a front plane of the frame, the rear surfaces of the frame members defining a rear plane of the frame,;
load support means mounted on the frame for supporting a load on the frame; and
climbing means mounted on the frame for facilitating movement of the frame up and down a ledge, the climbing means being mounted on the frame toward the lower end of the frame, the climbing means extending through the front plane of the frame and through the rear plane of the frame.

2. The apparatus of claim 1 wherein the climbing means extends substantially the entire distance between the laterally spaced frame members.

2. The apparatus of claim 1 wherein the climbing means comprises an endless belt having an upper end portion positioned toward the upper end of the frame and a lower end portion positioned toward the lower end of the frame, the endless belt having a rearward stretch defining the support surface, the endless belt having an interior space.

3. The apparatus of claim 2 wherein the endless belt has an outward perimeter surface with a plurality of ribs formed thereon, the plurality of ribs extending laterally between side edges of the endless belt

4. The apparatus of claim 2 additionally comprising rotating means for rotating the endless belt.

5. The apparatus of claim 4 wherein the rotating means comprises:
a pair of rollers on which the endless belt is mounted, each of the rollers being positioned at each of the end portions of the endless belt, the rollers being mounted on the frame members of the frame and extending between the frame members; and
a motor for rotating the rollers, the motor being mounted on the frame, the motor being positioned in the interior space of the endless belt.

6. The apparatus of claim 5 additionally comprising tensioning means for adjusting tension of the endless belt, the tensioning means adjusting a distance between the rollers.

7. The apparatus of claim 4 additionally comprising a battery positioned in the interior space of the endless belt.

8. The apparatus of claim 1 wherein the frame further comprises a first cross member extending between the pair of frame members, the first cross member being positioned toward the upper end of the frame.

9. The apparatus of claim 8 wherein the frame further comprisis a second cross member extending between the pair of frame members, the second cross member being positioned between the first cross member and the lower end of the frame.

10. The apparatus of claim 9 wherein the frame further comprises a third cross member extending between the pair of frame members, the third cross member being positioned between the first cross member and the second cross member.

11. The apparatus of claim 1 wherein the load support means is mounted on each of the frame members.

12. The apparatus of claim 1 wherein the load supporting means comprises at least one bracket, the at least one bracket being mounted on one of the frame members.

13. The apparatus of claim 12 wherein the load support means comprises four of the brackets, each of the brackets being mounted on the front surfaces of the frame members.

14. The apparatus of claim 12 wherein each of the brackets comprises a channel structure.
